(19) United States
(12) Patent Application Publication
(10) Pub. No.: US 2002/0175123 A1
(43) Pub. Date: Nov. 28, 2002

(54) Process and an apparatus for the separation of oil from chopped elastane fibers which contain preparations

(76) Inventors: Wolfgang Anderheggen, Dormagen (DE); Toni Herbertz, Dormagen (DE); Ulrich Reinehr, Dormagen (DE); Tilo Sehm, Dusseldorf (DE)

Correspondence Address: WILLIAM GERSTENZANG, NORRIS, MCLAUGHLIN & MARCUS, P.A., 220 EAST 42ND STREET, 30TH FLOOR, NEW YORK, NY, 10017, US

(21) Appl. No.: 10/055,652

(22) Filed: Jan. 23, 2002

(30) Foreign Application Priority Data
Jan. 24, 2001 (DE) 10103029.0

(51) Int. Cl. C02F 1/44

(52) U.S. Cl. 210/639; 210/774; 210/806; 210/669

(57) ABSTRACT

A process and an apparatus are described for separating at least 50% by weight of oleaginous preparation media from elastane fibers which contain preparations, with respect to 100% by weight of the initial content of preparation media in the elastane starting material, wherein a mixture of elastane fibers of different titres is used as chopped fiber, wherein fibers with a titre of 11 to 10,000 dtex or more are used as a starting material, which chopped elastane fibers are mixed with water in a mixing vessel in a bath ratio of water to chopped elastane fibers of at least 5/1, wherein mixing is effected using mixing devices (3) with a speed of rotation of at least 1500 rpm, treatment is carried out at room temperature or at an elevated temperature, particularly up to 90° C., a treatment duration of 10 to 60 minutes is maintained, and the aqueous bat which contains preparation media is subsequently separated from the fiber material.

This invention relates to a process and an apparatus for the separation of oil from chopped elastane fibers which contain preparation oils and which are provided for reprocessing. A process for producing elastane fibers from recycled material by dry spinning or wet spinning methods has become known from DE-OS 19 907 830. The starting material used there is elastane waste material, which is produced by the comminution of elastane fibers to give cut lengths of at least 1 mm. Homogeneous elastane spinning solutions can be produced from the comminuted elastane fibers by employing a spinning solvent with the addition of a secondary aliphatic amine, which spinning solvent is optionally mixed with fresh elastane solutions, and can be spun to produce ready-to-use elastane fibers.

The term “elastane fibers” is to be understood to mean fibers, having an at least 85% by weight content of segmented polyurethanes or polyurethane-ureas. Said polyurethane-ureas are synthesized so that the macromolecule has a segmented structure comprising crystalline blocks (hard segments) and amorphous blocks (soft segments).

### BACKGROUND OF THE INVENTION

To improve their behavior during further processing, elastane fibers are treated with mixtures of lubricants which are termed “preparation oils”, before they are wound on spools. Depending on their type and titre, the elastane fibers which are used for comminution into cut fibers have different contents of preparation oils ranging from about 3 to about 15% by weight with respect to elastane solids. In general, the content of preparation oil deposited on elastane fibers which contain a polyester component (PES) as a plasticizer ranges from 3 to 7% by weight, whereas for elastane fibers which contain a polyether component (PET) as a plasticizer, contents of preparation oil up to 15% by weight are customary. High contents of preparation oils are preferably used for very fine elastane fibers with titres less than 33 dtex.

The preparation oils generally used are mineral oils, silicone oils and metal salts of fatty acids. According to EP 046 073 A2, one preferred preparation for elastane fibers which have been produced by the dry spinning method is a mixture having 90% wt. polydimethylsiloxane and 10% wt. polyamylsiloxane to which 4 to 10% wt of a metal salt of a fatty acid, with respect to the total weight of the preparation, has been added. The metal of the fatty acid salt is calcium, lithium or magnesium. The fatty acid is selected from the group comprising unsaturated and saturated fatty acids containing 10-12 carbon atoms.

One preparation mixture which is preferably used, for example, consists of 91% polydimethylsiloxane, 5% polyamylsiloxane and 4% magnesium stearate.

According to DD 251 587, a spinning preparation consisting of an aqueous suspension of magnesium and/or calcium stearate and an emulsion of polydimethylsiloxane can be added at a concentration of 1-20 g/liter to elastane fibers which have been produced by the wet spinning method.

During the reprocessing of chopped elastane fibers of the aforementioned type which contain preparations, the high contents of mixtures of preparation media constitute a considerable problem. In dry spinning, the preparations are entrained by the spinning solution into the spinning shafts, and in wet spinning they come into contact with fixing devices such as calenders or heated rolls, where they partially volatilize and decompose. Moreover, not inconsiderable amounts of preparation media condense on cooler places of production installations, which can result in deposits or oil which drips from the elastane fibers produced, and can result in blockages and problems in the course of processing.

It has therefore been proposed in Patent Specification CA 771 086 that preparations which are present on elastane fibers be washed from the elastane fibers with the solvents acetone or isopropyl alcohol. A process of this type is very costly (it necessitates the use of explosion-proof apparatuses) and also necessitates careful drying of the elastane fibers, since even small amounts of residual solvents contaminate the elastane spinning solutions, which in turn can result in spinning problems.

Patent Specification EP 881 324 A2 also proposes a process for the simultaneous removal of brighteners from and for the coloration of synthetic fibers, wherein aqueous baths are employed to which surfactants, such as betaines, amine oxides and terpene hydrocarbons are added, and dyes are added within the pH range between 4 and 7.5. Due to its many treatment steps, such as cooling, discharge, coiling and post-treatment, this process is also very costly and time-consuming, and it is also unsuitable for environmental reasons for removing preparations from chopped elastane fibers on an industrial scale, due to the many additives employed.

Other investigations have employed solvents using such as toluene, cyclohexane, 1-butenol or 1,1,1-trichloroethane for leaching preparation oils out of chopped elastane fibers, but the use thereof on an industrial scale is not viable on account of too high a solvent requirement. The maximum content of preparation oil in the aforementioned solvents is 5% by weight. Moreover, the solid/liquid separation products can only be worked up using expensive equipment. Thus, for example, the cyclohexane content of chopped elastane fibers after washing and filtration is still about 110% by weight, and after a further separation operation is still about 40-50% by weight, and after yet an additional pressing operation is still about 35-40% by weight of residual solvent.

Since, under these conditions, even after the drying of chopped elastane fibers the drag-in of solvents into spinning and distillation process can hardly be avoided completely, the aforementioned solvents are unsuitable for washing out preparation oils from chopped elastane fibers without considerable expenditure on plant and energy.

The object of the present invention was therefore to provide a process for the separation of oil from chopped elastane fibers which contain preparation oils, which does not exhibit the aforementioned disadvantages and which can be implemented in a cost-effective manner on an industrial scale.

### SUMMARY OF THE INVENTION

It has now surprisingly been found that said preparation oils can be separated very satisfactorily by a mechanical route from recycled elastane material, namely from aqueous baths by treatment with high-speed mixing devices. Depending on the bath ratio of water to recycled elastane material, the treatment duration, the treatment temperature, the titre mix and the speed of rotation of the mixing devices, and on the spacing between the shearing devices in the mixing vessel, up to about 90% by weight of the preparation oils which were originally present on or in the fibers can be separated from recycled elastane material.

Preferably, no chemical emulsifiers are added.

### DETAILED DESCRIPTION

The polydimethylsiloxane content of the starting material is determined by H NMR analysis. The polydimethylsiloxane content of the chopped elastane fibers after treatment with an aqueous bath is determined by the same method after drying the cut fibers for one hour in a recirculating air drying oven at 100° C. The polydimethylsiloxane content of the aqueous bath is determined as follows: the aqueous bath is shaken with chloroform and the silicone oil in the extract is likewise quantitatively determined by H NMR analysis.

The loss of preparation from the recycled elastane material is calculated as follows:

$$loss of preparation ( \% ) = 100 - ( \frac{\begin{matrix}oil content of the cut elastane \\ fibres afterwards - ( \% by weight )\end{matrix} }{\begin{matrix}oil content of the cut elastane \\ fibres beforehand ( \% by weight )\end{matrix} } \times 100 )$$

The present invention relates to a process for separating at least 30% by weight, preferably at least 50% by weight, of oleaginous preparation media from elastane fibers which contain preparation oils, preferably preparation media which contain polydialkylsiloxane, most preferably polydimethylsiloxane, with respect to 100% by weight of the initial content of preparation media in the elastane starting material, wherein

a) a mixture of elastane fibers of different titres is used as the chopped fiber, wherein fibers having titres in the range of about 11 to about 10,000 dtex or more are used as the starting material, and in particular the proportion of fibers having titres less than or equal to 900 dtex is maintained at less than 80% by weight with respect to 100% by weight of the initial weight of fibers,

b) the chopped elastane fibers are mixed with a bath of water in a mixing vessel at a ratio of water to chopped elastane fibers of at least 5/1,

c) mixing is effected using rotating mixing devices with a speed of rotation of at least 1200 rpm,

d) mixing is effected at room temperature or at an elevated temperature, preferably up to 90° C., particularly preferably up to 70° C.,

e) mixing is continued for a duration of 10 to 60 minutes, and

f) whereby at least a portion of preparation media is removed from the fiber material by the water in the bath, and the fiber material is then separated from the aqueous bath.

The term “recycled elastane material” is hereinafter to be understood to mean chopped elastane fibers of the polyester and/or polyether type which have contents of preparation oil which are typically 3-15% by weight.

Preparation oils in the sense of the invention typically consist of mineral oils and/or silicone oils, optionally with the addition of metal salts of fatty acids. For example, one preparation for elastane fibers consists of 90% polydimethylsiloxane and 10% polyamylsiloxane with 4-10% by weight of a metal salt of a fatty acid, with respect to the total weight of the preparation. The metal of the fatty acid salt is usually calcium, lithium, or magnesium. The fatty acid is selected from the group comprising unsaturated and saturated fatty acids containing 10-12 carbon atoms.

Elastanes based on polyether urethanes and/or polyester urethanes, or mixtures of polyether- and polyester-based chopped elastane fibers in any mixture ratio, are preferably used as chopped elastane fibers.

In one advantageous variant of the process, the mixing devices consist of at least two stirrer shafts with at least 2 dissolver discs per stirrer, and with a ratio of the diameter of the dissolver discs to the diameter of the vessel which ranges from 1 to 5 to 3 to 5.

Thee speed of rotation the stirrer shafts is preferably at least 2000 rpm, most preferably at least 3000 rpm.

By means of these measures, the efficacy of release of the preparation media from the fibers is increased. In order to prevent settling and caking together of fiber material, in one preferred process variant the mixture is additionally agitated by an anchor stirrer.

The speed of rotation of the anchor stirrer is preferably at least 50 rpm, most preferably 60 to 100 rpm.

The process is carried out particularly effectively if the quantitative ratio of water to elastane fiber material ranges from 5/1 to 15/1, preferably 5/1 to 10/1.

The mixing duration of the elastane fiber material with the aqueous bath in the mixing vessel ranges from 15 to 60 minutes; preferably from 15 to 45 minutes, particularly preferably from 30 to 45 minutes.

A variant of the process is also preferred in which the temperature of the contents of the mixing vessel at the start of the mixing of the elastane fibers with the bath of water ranges from room temperature to 70° C.

The material in the mixing vessel may also be heated somewhat by the mechanical energy introduced by the mixers in the course of mixing.

The present invention further relates to a process for producing elastane spinning solutions from elastane chopped fiber material, wherein separation of preparation media from the fiber material is firstly effected by the separation process according to the invention, and then, after separation of the fiber material from the aqueous bath in the mixing vessel, the elastane fiber material is dewatered via a suitable processing unit, such as a screen, a centrifuge and/or a press, the elastane fiber material is subsequently dried at a temperature of at least 100° C. to a residual moisture content of less than 5% by weight, preferably 1 to 3% by weight, particularly preferably 0.5 to 1.0% by weight, with respect to its solids content, and is dissolved in a spinning solvent, such as dimethylformamide or dimethylacetamide, with the addition of a secondary aliphatic amine, and is converted into a homogeneous elastane spinning solution.

The present invention also relates to an apparatus for carrying out the process according to the invention, comprising at least a mixing vessel, which can optionally be heated, and of a dispersing unit comprising at least two stirrer shafts, each of which is fitted with at least one, preferably two dissolver discs.

An apparatus is preferred in which a central stirrer, particularly an anchor stirrer, is additionally provided which can be operated at a lower speed of rotation than the stirrer shafts mentioned above.

The present invention also relates to an apparatus for carrying out the process according to the invention, comprising at least a mixing vessel, which can optionally be heated, and of a dispersing unit comprising at least two stirrer shafts, each of which is fitted with at least one, preferably two dissolver discs.

An apparatus is preferred in which a central stirrer, particularly an anchor stirrer, is additionally provided which can be operated at a lower speed of rotation than the stirrer shafts mentioned above.

Also preferred is a variant of said apparatus in which the mixing vessel is provided with an additional shipping device for the rotating components of the stirrer.

### BRIEF DESCRIPTION OF THE DRAWINGS

FIG. 1 illustrates a mixing vessel of the invention, having a dispersing unit comprised of two stirrer shafts, each of which is fitted with two dissolver discs, and an anchor stirrer and stripper elements.

FIG. 2 illustrates a mixing vessel of the invention, having a dispersing unit comprised of two stirrer shafts, each of which is fitted with two dissolver discs, and a multiflow device having inclined ribs and a centrally disposed shaft.

The following examples serve to explain the invention in greater detail, but do not limit the invention. All percentages are given as percentages by weight unless stated otherwise.

### EXAMPLES

Example No. 1

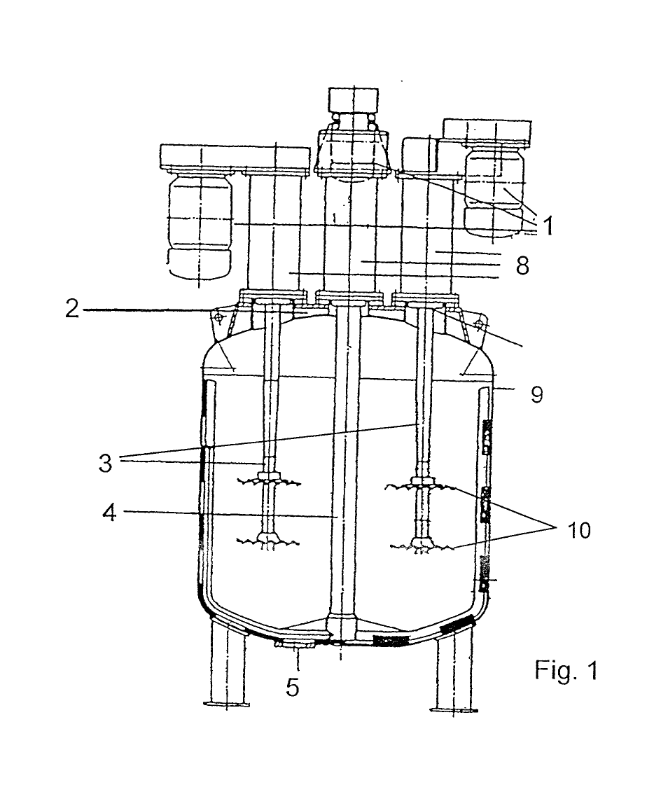

4.8 kg recycled elastane fiber material comprising a titre mix of 45-1280 dtex and a content of polydimethylsiloxane-containing preparation of 4.8% by weight, consisting of 100% of a pure type of polyester (PES), was introduced, with stirring, into a 100 liter mixing vessel 9 with an inside diameter of 485 mm (see FIG. 1) in 55 liters of water at room temperature (24.7° C.). The bath ratio of water to recycled fiber material was 11.511. The time of introduction was about 3 minutes. The mixing vessel was fitted with two high-speed stirrer shafts 3, termed “dissolvers”, which were each equipped with two dissolver discs 10 of 150 mm diameter. In addition, an anchor stirrer 4 comprising a stripping element 6 ensured that no accumulations of fiber were formed at the edge of the vessel. During the period of introduction, the two dissolvers 3 ran at a speed of rotation of about 1000 rpm. After the introduction of the recycled elastane material was complete, the two dissolvers 3 were operated at about 3100 rpm for an additional 60 minutes. Over this period, the water temperature rose to 60° C. During the entire test duration of 60 minutes, the anchor stirrer 4 was operated at a speed of rotation of about 65 rpm. After 15, 30, 45, and 60 minutes treatment duration, samples were taken of the recycled elastane material and of the bath water, and the polydimethylsiloxane content thereof was determined by H NMR.

The bath was subsequently discharged, and the recycled elastane material was removed by suction through a screen and was pressed with a plunger. The recycled elastane material, which still had a residual moisture content of about 38% by weight, was then dried for one hour at 100° C. (residual moisture content<1% by weight) and was subsequently used as described at the outset for the production of an elastane spinning solution.

The polydimethylsiloxane (PDMS) content of the recycled elastane material was as follows:

| | | | | |
|---|---|---|---|---|
| Treatment time (minutes) | 15 | 30 | 45 | 60 |
| Content of PDMS beforehand (% by | 4.8 | 4.8 | 4.8 | 4.8 |
| weight) | | | | |
| Content of PDMS afterwards (% by weight) | 2.1 | 1, 4 | 1, 1 | 1, 3 |
| Content of PDMS in water (% by weight) | 0.23 | 0.29 | 0.32 | 0.30 |
| Loss of PDMS from recycled material (% | 56.3 | 70.8 | 77.1 | 72.9 |
| by weight) | | | | |

As can be seen from this example, the highest loss of preparation, namely 77.1%, was achieved at a treatment time of 45 minutes. The emulsion of water and polydimethylsiloxane, which contained oil, obviously attained its maximum degree of saturation during a treatment of 45 minutes, while the loss of preparation decreased again for a treatment duration of 60 minutes. This finding was also confirmed by the lower content of preparation in the water after a treatment duration of 60 minutes.

Examples 2-16

The results obtained using other embodiments of the present invention are listed in Table 1 below as Examples 2-16. In each case, the vessel 9 comprised 2 stirrer shafts 3 which were each equipped with two dissolver discs 10 of 150 mm diameter, and comprised an anchor stirrer 4 with stripping elements 6 with a speed of rotation of 50-60 rpm (see FIG. 1). Either a pure PET or PES type of material, or a titre mix comprising polyester (PES) and the polyether (PET) types with a titre range between 17 and 1280 dtex was used as the recycled elastane material. The following parameters were varied: the bath ratio, the ratio of polyether and polyester types with different initial contents of polydimethylsiloxanes, the speed of rotation of the stirrers, and the treatment duration and treatment temperature. As can be seen from Table 1, the magnitude of the loss of preparation from the recycled elastane material is very strongly dependent on the bath ratio of water to recycled material which was used.

Whereas at a bath ratio of 11.5/1 according to Example 1, the loss of preparation from the fiber material after a treatment duration of 45 minutes was 77.1%, at a bath ratio of 7.5/1 according to Example 2 an 81.2% loss of preparation was achieved, and finally at a bath ratio of 5/1 according to Example 3 a 90.6% loss of preparation was achieved. At even lower bath ratios the limit of mechanical performance was reached at the high speeds of rotation used. In Example No.4, recycled elastane material was employed which comprised a pure polyether (PET) type. Compared to Example No. 2, where a pure polyester (PES) type was used under the same conditions, the loss of preparation was 64.4% instead of 81.2%. The reduced loss of preparation in the case of the polyether type is probably due to the different titre mix. At a coarser titre mix of 45-1280 dtex in the case of the polyester type, there was probably less caking of the fiber material. In other words, recycled material of the polyester type was present in a “looser” form. As shown by Examples Nos. 5 and 6, the polyether/polyester type mixture ratio, as well as the respective initial content of preparation of the recycled elastane material, does not play a significant part as regards the magnitude of the loss of preparation from the recycled elastane material. In Examples Nos. 7 to 9 it is shown that the loss in preparation from the recycled elastane material increases considerably with increasing speed of rotation of the stirrer shafts. When both stirrer shafts were operated at a speed of rotation of 1500 rpm, the loss of preparation was only 37.3% (Example No. 7), at a speed of rotation of 2000 rpm it was 51.0% (Example No. 8) and at a speed of rotation of 3500 rpm there was a 73.5% loss of preparation (Example No. 9). In Examples Nos. 10 to 12, the water temperature in the mixing vessel was increased from room temperature to 60° C., and was then increased via 70° C. to 90° C. by inserting an auxiliary steam heater. As can be seen from Table 1, an increase in temperature above 70° C. did not result in an increase in the loss of preparation. Whereas after treatment at room temperature the loss of preparation was 63.7% (see Example No. 14), the loss of preparation at a treatment temperature of 60° C. was 67.6% (Example No. 10), at a treatment temperature of 70° C. the loss of preparation was 68.6% (Example No. 11), and at a treatment temperature of 90° C. the loss of preparation was only 44.1% (Example No. 12). It follows from Examples Nos. 13 to 15 that for a treatment duration longer than about 45 minutes (see Example No. 14, loss of preparation=63.7%) the loss of preparation from the recycled material decreases again (see Example No. 15, loss of preparation=52.0%). The emulsion of water and polydimethylsiloxane had obviously reached its maximum degree of saturation at a treatment duration of about 45 minutes. Example No. 16 shows that at a bath ratio of water to recycled elastane material of 15:1 the loss of preparation in the recycled material is still 53.9%.

TABLE 1

| | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|
| water (kg) | 55 | 55 | 55 | 55 | 55 | 55 | 55 | 55 | 55 | 55 | 55 | 55 | 55 | 55 | 55 |
| recycled material (kg) | 7.33 | 11 | 4.8 | 5.5 | 5.5 | 5.5 | 5.5 | 5.5 | 5.5 | 5.5 | 5.5 | 5.5 | 5.5 | 5.5 | 3.67 |
| titre mix (dtex) | 45- | 45- | 17- | 17- | 17- | 17- | 17- | 17- | 17- | 17- | 17- | 17- | 17- | 17- | 17- |
| | 1280 | 1280 | 270 | 1280 | 1280 | 1280 | 1280 | 1280 | 1280 | 1280 | 1280 | 1280 | 1280 | 1280 | 1280 |
| bath ratio | 7.5/1 | 5/1 | 11.5/1 | 10/1 | 10/1 | 10/1 | 10/1 | 10/1 | 10/1 | 10/1 | 10/1 | 10/1 | 10/1 | 10/1 | 15/1 |
| (water/recycled material) | | | | | | | | | | | | | | | |
| PET/PES type ratio | 0/1 | 0/1 | 1/0 | 7/3 | 3/7 | 1/1 | 1/1 | 1/1 | 1/1 | 1/1 | 1/1 | 1/1 | 1/1 | 1/1 | 1/1 |
| stirrer shafts rpm | 3115 | 3115 | 3115 | 3115 | 3115 | 1500 | 2000 | 3500 | 3115 | 3115 | 3115 | 3115 | 3115 | 3115 | 3115 |
| treatment duration (min) | 45 | 45 | 45 | 45 | 45 | 45 | 45 | 45 | 45 | 45 | 45 | 30 | 45 | 60 | 45 |
| Initial temperature (° C.) | 24.7 | 24.7 | 24.7 | 24.7 | 24.7 | 24.7 | 24.7 | 24.7 | 60 | 70 | 90 | 24.7 | 24.7 | 24.7 | 24.7 |
| conteo fnt preparation beforehand | 4.8 | 4.8 | 14.6 | 8.5 | 6.4 | 10.2 | 10.2 | 10.2 | 10.2 | 10.5 | 10.2 | 10.2 | 10.2 | 10.2 | 10.2 |
| (% by weight) | | | | | | | | | | | | | | | |
| content of preparation | 0.9 | 0.45 | 5.2 | 2.8 | 2.0 | 6.4 | 5.0 | 2.7 | 3.3 | 3.2 | 5.7 | 3.8 | 3.7 | 4.9 | 4.7 |
| afterwards (% by weight) | | | | | | | | | | | | | | | |
| Loss of preparation (%) | 81.2 | 90.6 | 64.4 | 67.1 | 68.7 | 37.3 | 51.0 | 73.5 | 67.6 | 68.6 | 44.1 | 62.7 | 63.7 | 52.0 | 53.9 |
| from recycled elastane | | | | | | | | | | | | | | | |
| material | | | | | | | | | | | | | | | |

Example No. 17 (not according to the invention)

4.8 kg of an recycled elastane material of titre 160 dtex and with an initial preparation content of 8.8% by weight, consisting of a pure polyether type (PET), was introduced as described in Example No. 1, with stirring, into 55 liters water at room temperature (24.7° C.) in a 100 liter mixing vessel and was further treated as described there. The cut fibers for recycling formed lumps and the speed of rotation of the two stirrer shafts therefore had to be reduced below 1000 rpm to about 800 rpm. The test had to be abandoned due to the lumping together of fibers, to prevent damage to the stirrers.

In contrast to titre mixes containing proportions of coarse titre fibers, recycled elastane material which solely consists of fine titre is thus not suitable unconditionally for the present process.

Example No. 18

5.5 kg recycled elastane material comprising a titre mix of 17-1280 dtex and an initial preparation content of 10.2% by weight, consisting of PET and PES types in a mixture ratio of 1/1, was introduced, with stirring, into 55 titres water at 24.7° C. in a 100 liter mixing vessel. The mixing device of the mixing vessel consisted of a centrally disposed stirrer only, fitted with a dissolver disc of 350 mm diameter. The bath ratio of water to recycled elastane material was 1/1. After an introduction time of about 3 minutes at a speed of rotation of about 500 rpm, the stirrer shaft was operated for a further 42 minutes at the highest possible speed of rotation of 1255 rpm. An additional baffle in the vessel ensured better mixing throughout. Moreover, the mixing vessel was operated without an anchor stirrer and stripping elements. After a total of 45 minutes treatment duration, the bath was discharged, the recycled elastane material was removed by suction through a screen, and was pressed and dried for 1 hour in a recirculating air drying oven at 100° C. The residual polydimethylsiloxane content of the recycled elastane material was 6.3% by weight. The total loss of preparation was thus 38.2%.

As can be seen from a comparison with Example 14 in Table 1, the good results obtained in Example No. 14 were not achieved when only one stirrer was used instead of two, despite the larger dissolver discs and the baffles (Example No. 14: loss of preparation=63.7%).

Example No. 19

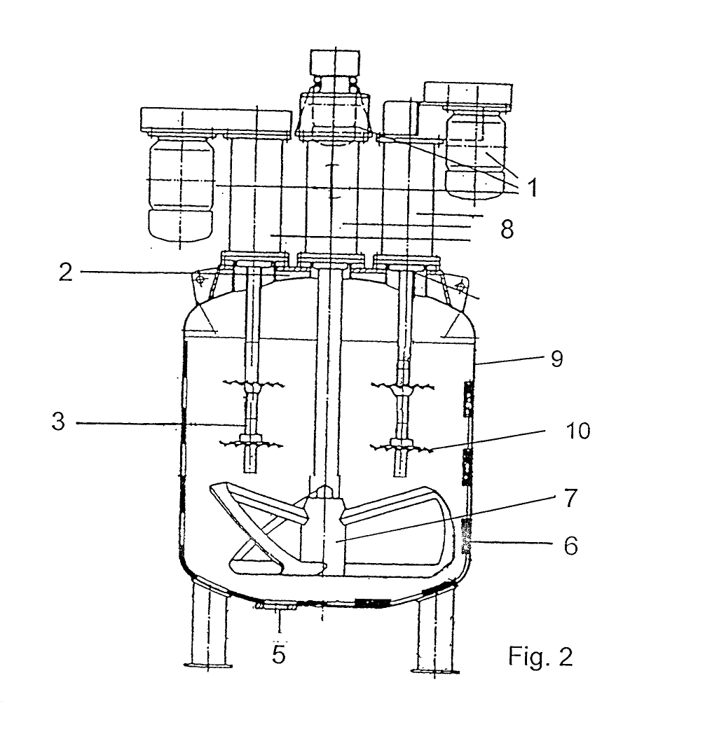

The starting material here was the same recycled elastane material which was described in Example No. 18 (content of preparation=10.2% by weight), and the same PET/PES type mixture ratio and bath ratio of water to recycled elastane material of 10/1 were also used. However, the procedure employed was that described in Example No. 1, comprising 2 stirrer shafts and 2 dissolver discs per shaft, of diameter 150 mm. Instead of an anchor stirrer with stripping elements, however, what is termed a multi-flow device was used (see FIG. 2, reference numeral 7) which had inclined ribs and a centrally disposed shaft. The treatment duration was again 60 minutes in total. The two stirrers/dispersing devices were again operated at a speed of rotation of about 3100 rpm and the multi-flow stirrer was operated at about 120 rpm during the entire treatment duration. The bath was subsequently discharged, and the recycled elastane material was removed by suction through a screen and pressed by a plunger. The recycled elastane material, which still had an average moisture content of about 39.5% by weight, was then dried for one hour at 100° C. and was subsequently reused for the production of an elastane spinning solution.

The polydimethylsiloxane content of the recycled elastane material was as follows:

| | | | |
|---|---|---|---|
| Treatment time (minutes) | 30 | 45 | 60 |
| Content of preparation beforehand (% by | 10.2 | 10.2 | 10.2 |
| weight) | | | |
| Content of preparation afterwards (% by | 6.2 | 5.6 | 6.0 |
| weight) | | | |
| Content of preparation in water (% by | 0.40 | 0.48 | 0.42 |
| weight) | | | |
| Loss of preparation from recycled | 39.2 | 45.1 | 41.2 |
| material (%) | | | |

Compared with Examples Nos. 13-15 as listed in Table 1 (with an anchor stirrer), good results were not obtained in Example 19, where an anchor stirrer and stripping elements were replaced by a multi-flow stirrer, despite the same speed of rotation of the stirrer shafts (loss of preparation in Example No. 13 after a treatment duration of 30 minutes=62.7% compared with 39.2% in Example No. 19; loss of preparation in Example No. 14 after a treatment duration of 45 minutes=63.7% instead of 45.1% in Example No. 19, and loss of preparation in Example No. 15 after a treatment duration of 60 minutes=52.0% instead of 41.2% in Example No. 19). It was also ascertained that after a longer treatment duration of 60 minutes instead of 30 to 45 minutes the loss of preparation from the recycled elastane material decreased considerably again. This was also confirmed again by the decreasing content of preparation in the bath.

Example No. 20 (not according to the invention)

The starting material was again the same recycled elastane material described in Example No.18. The PET/PES mixture ratio of the recycled material and the bath ratio of 10/1 were also the same. The mixing vessel was fitted with only one conventional paddle wheel stirrer (not shown) which was seated on a central shaft. The treatment duration was 45 minutes. The paddle wheel stirrer was operated during the time of introduction (about 3 minutes) of the recycled material at a speed of rotation of 60 rpm, and was subsequently operated at the highest possible speed of rotation of about 195 rpm. The residual polydimethylsiloxane content was 8.8% by weight, corresponding to a loss of oil of only 13.7%. As can be seen from comparative example No. 20, satisfactory results for the separation of polydimethylsiloxanes from recycled elastane material were not obtained with conventional stirrers and at low speeds of rotation.

We claim:

1. a process for separating at least 30% by weight of the polydimethylsiloxane-containing preparation oil from elastane fibers which contain such preparation oils, which comprises
a) preparing a mixture of chopped elastane fibers of different titres, comprising fibers with titres in the range of about 11 to about 10,000 dtex and in which the proportion of fibers with a titre less than or equal to 900 dtex is less than 80% by weight of the total mixture of fibers,
b) mixing the chopped elastane fiber mixture with a bath of water in a mixing vessel having rotating mixers at a ratio of water to chopped elastane fibers of at least 5/1 by weight,
c) mixing said fiber mixture and said water at a speed of rotation of said rotating mixers of at least 1200 rpm,
d) maintaining the mixing vessel contents at a temperature ranging from room temperature to 90° C. during said mixing of the fibers and the water,
e) continuing the mixing of the fibers and the water for a duration of 10 to 60 minutes, and then
f) separating the fiber material from the bath of water:

2. The process of claim 1, wherein the elastane fibers are polyether urethane fibers, polyester urethane fibers or mixtures of polyether-urethane fibers and polyester urethane fibers.

3. The process of claim 1, wherein the mixing devices consist of at least two stirrer shafts, each having with at least 2 dissolver discs per stirrer, and wherein the ratios of the diameters of the dissolver discs to the diameter of the vessel rang from about 1 to 5 to about 3 to 5.

4. The process of claim 1, 2 or 3, wherein the speed of rotation of the stirrer shafts 3 is at least 2000 rpm.

5. The process of claim 3, wherein the mixture is additionally agitated by an anchor stirrer.

6. The process of claim 5, wherein the speed of rotation of the anchor stirrer is at least 50 rpm.

7. The process of claim 1, 2, 3, 5 or 6, wherein the weight ratio of water to elastane fiber material in the mixture of fibers and water ranges from 5/1 to 15/1.

8. The process of claim 1, 2, 3, 5 or 6, wherein the mixing duration of the elastane fiber material and water in the mixing vessel ranges from 15 to 45 minutes.

9. The process of claim 1, 2, 3, 5 or 6, wherein the temperature of the mixing vessel contents at the start of mixing ranges from room temperature to 70° C.

10. A process for producing elastane spinning solutions from elastane chopped fiber material, preparation oil is first separated from said chopped fiber material, according to the process of claim 1, 2, 3, 5, or 6 and, after separation of the fibers from the bath of water the elastane fiber material is dewatered and then dried at a temperature of at least 100° C. to a residual moisture content of less than 5% by weight, with respect to its solids content, and is dissolved in a spinning solvent to form a homogeneous elastane spinning solution.

11. An apparatus for the carrying out a process according to claim 1 or 10, comprising at least of a mixing vessel, which optionally includes a heater, and which includes a dispersing unit comprised of at least two stirrer shafts, each of which is provided with at least one dissolver disc.

12. The apparatus of claim 11, wherein said mixing vessel further comprises an anchor stirrer, adapted to be operated at a speed of rotation that is lower than the speed of rotation of said stirrer shafts.

13. The apparatus of claim 11 or 12, wherein the mixing vessel is further provided with an stripping device adapted to remove fiber material from the anchor stirrer.

14. The process of claim 4 wherein said speed of rotation is at least 3000 rpm.

15. The process of claim 6, wherein said speed of rotation is 60 to 100 rpm.

16. The process of claim 7, wherein said ratio is from 5/1 to 10/1.

17. The process of claim 8, wherein said duration is 30 to 45 minutes.

18. The process of claim 10, wherein said residual moisture content is 1 to 3% by weight.

19. The process of claim 18, wherein said residual moisture content is 0.5 to 1.0% by weight.

20. The process of claim 10, wherein said spinning solvent is selected from the group consisting of dimethylformamide and dimethylacetamide.

21. The process of claim 10 wherein a secondary aliphatic amine is added to said solvent.

22. The apparatus of claim 11, wherein said stirrer shafts are each provided with two dissolver discs.
